(19) United States
(12) Patent Application Publication
(10) Pub. No.: US 2024/0300809 A1
(43) Pub. Date: Sep. 12, 2024

(54) SYSTEMS FOR HEAT PRESERVATION DURING HYDROGENATION AND DEHYDROGENATION

(71) Applicant: CHEVRON U.S.A. INC., San Ramon, CA (US)

(72) Inventors: Kevin Jakubenas, San Ramon, CA (US); Allen M. Toweill, San Ramon, CA (US)

(21) Appl. No.: 18/591,526

(22) Filed: Feb. 29, 2024

Related U.S. Application Data
(60) Provisional application No. 63/449,156, filed on Mar. 1, 2023.

(51) Int. Cl. C01B 3/00

(52) U.S. Cl. CPC C01B 3/0015; C01B 2203/0805; C01B 2203/1619; C01B 2203/169

(57) ABSTRACT

The invention relates generally to system for conserving heat during the hydrogenation and dehydrogenation process by using a multi-component system.

### CROSS-REFERENCE TO RELATED APPLICATIONS

This application claims priority to U.S. Provisional Application No. 63/449,156 filed on Mar. 1, 2023 the contents of which are incorporated herein in their entirety.

### FIELD OF THE DISCLOSURE

The present disclosure related to systems for multi-component transportation of hydrogen.

### BACKGROUND

Because hydrogen is a low-density gas, it is expensive to transport long distances. One method that has been used to overcome the transport problem is to add hydrogen to a molecule at the origination (hydrogenation) and then remove hydrogen from the molecule at the destination (dehydrogenation). The problem is that hydrogenation and/or dehydrogenation require heat at either the origination or destination. This heat is typically lost during the dehydrogenation or hydrogenation and therefore adds to the expense of the hydrogen transport. Adding or removing heat also requires additional equipment such as heat exchangers and either a source of heat or a place to send heat. This additional equipment also adds to cost of transporting hydrogen.

These and other deficiencies exist. Therefore, there is a need to provide systems that overcome these deficiencies.

### SUMMARY OF THE DISCLOSURE

In some aspects, the techniques described herein relate to a method for balancing the flow of heat between exothermic dehydrogenation and endothermic dehydrogenation materials to minimize the amount of external heat needed for dehydrogenation including: (a) providing a first component and second component in which the first component absorbs heat during a dehydrogenation process and the second component releases heat during a dehydrogenation process; (b) providing for thermal communication between the first component and the second component; (c) controlling temperature of each of the first and second components so as to control the dehydrogenation rate of reaction; and (d) providing a ratio of first and second components to achieve an objective selected from the group consisting of (i) zero heat added for dehydrogenation, (ii) zero heat added for hydrogenation, (iii) a minimum total heat needed for a full cycle of hydrogenation and dehydrogenation, and (iv) combinations thereof.

In some aspects, the techniques described herein relate to a system for balancing the flow of heat between exothermic dehydrogenation and endothermic dehydrogenation materials to minimize the amount of external heat needed for dehydrogenation, the system including: a first component configured to absorbs heat during a dehydrogenation process; a second component configured to release heat during a dehydrogenation process, wherein a ratio of first and second components to achieve an objective selected from the group consisting of (i) zero heat added for dehydrogenation, (ii) zero heat added for hydrogenation, (iii) a minimum total heat needed for a full cycle of hydrogenation and dehydrogenation, and (iv) combinations thereof; and a thermal communication between the first component and the second component, wherein the temperature of the first and second components can be controlled by the thermal communication to affect a dehydrogenation rate of the dehydrogenation process.

In some aspects, the techniques described herein relate to a system for balancing the flow of heat between exothermic dehydrogenation and endothermic dehydrogenation materials to minimize the amount of external heat needed for dehydrogenation, the system including: a first component configured to absorbs heat during a dehydrogenation process; a second component configured release heat during a dehydrogenation process, wherein a ratio of first and second components to achieve an objective selected from the group consisting of (i) zero heat added for dehydrogenation, (ii) zero heat added for hydrogenation, (iii) a minimum total heat needed for a full cycle of hydrogenation and dehydrogenation, and (iv) combinations thereof; wherein the amounts of the first and second components are determined by an equation selected from the group consisting of:
wherein the amounts of the first and second components are determined by an equation selected from the group consisting of:
   c₁h₁^{hydrogenate}+c₂h₂^{hydrogenate}=heat required/released during hydrogenation;
   c₁h₁^{dehydrogenate}+c₂h₂^{dehydrogenate}=heat required/release during dehydrogenation;
   c₁+c₂=1; wherein
c₁=mole fraction of mixture component 1,
c₂=mole fraction of mixture component 2,
h₁^{hydrogenate}=molar heat required/released in hydrogenating component 1,
h₂^{hydrogenate}=molar heat required/released in hydrogenating component 2,
h₁^{dehydrogenate}=molar heat required/released in dehydrogenating component 2,
h₂^{dehydrogenate}=molar heat required/released in dehydrogenating component 2,
and combinations thereof;
   A generalized equation for n components:

$${{\sum }^{n}}_{1} {c}_{i} {h}_{i}^{hydrogenate} = heat required or released during hydrogenation$$

$${{\sum }^{n}}_{1} {c}_{i} {h}_{i}^{dehydrogenate} = heat required or released during hydrogenation$$

$${{\sum }^{n}}_{1} {c}_{i} = 1$$

n=number of components
cᵢ=mole fraction of component i
hᵢ^{hydrogenate}=molar heat required/released in hydrogenating component i
hᵢ^{dehydrogenate}=molar heat required/released in dehydrogenating component i

Further features of the disclosed systems, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a single component carrier system according to an exemplary embodiment.

FIG. 2 illustrates a multicomponent carrier system according to an exemplary embodiment.

FIG. 3 illustrates a two-component system according to an exemplary embodiment.

FIG. 4 illustrates a mixture composition graph.

FIGS. 5A and 5B illustrate multicomponent systems according to an exemplary embodiment

FIG. 6 illustrates the transfer of heat during hydrogenation and dehydrogenation according to representative embodiments.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All current liquid hydrogen carriers are single component systems. This invention is a multi-component liquid hydrogen carrier in which one component requires heat at origination and releases heat at the destination while the second component releases heat at origination and requires heat at the destination. The result is a liquid hydrogen carrier that has a greatly reduced need for heat to be supplied at either origination or destination of hydrogen transport. The result is lower energy loss from transportation and lower capital equipment costs at the origination and destination.

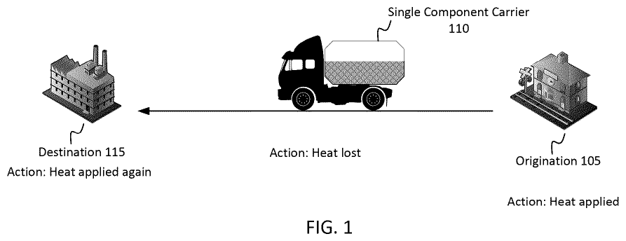

FIG. 1 illustrates a conventional method or system of transporting hydrogen (or some other low-density gas) using a single component system. At the site of origination 105, heat is applied to combine the hydrogen with some other element in a process called hydrogenation. The combined elements are placed in the single component carrier 110, e.g. a single tank or drum. The single component carrier 110 is then transported to the desire destination 115. The process of dehydrogenation requires heat to be added to release the hydrogen. There is no internal source of heat in the carrier. Thus, heat must be applied again at the destination 115. In either scenario, heat is either lost or preserved at the great expense of the user. Thus, the present embodiments offer a solution to this conventional method by preserving heat during transit (or at least reducing the amount of additional heat applied at the destination) using a multi-component system.

As one of skill will appreciate the transported material is typically not at an elevated temperature because the majority up to all of the heat energy has been converted to chemical bond energy by hydrogenation. When hydrogen is recovered during dehydrogenation at destination then heat energy is released. Heat is usually only a factor during hydrogenation/dehydrogenation reactions and advantageously, there is typically no substantial loss of energy in the carrier during transport.

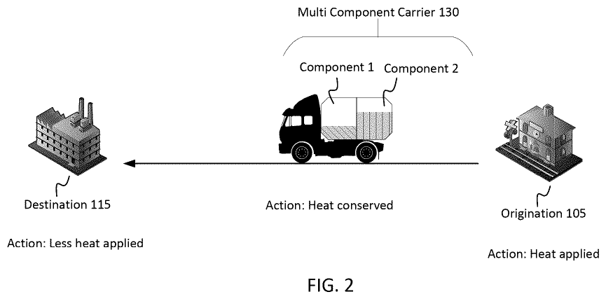

FIG. 2 illustrates a system for transporting hydrogen (or some other low-density gas) using a multi-component carrier 130, e.g. a two component system with component 1 and component 2. The components can be made of a chemical mixture. The mixture can either be a physical mixture of components or separate components that are in thermal communication. For example, in the simplest form, two separate tanks each containing a different component but sharing a common wall that conducts heat would achieve the desired effect. The components are inert and do not react with the other mixture components. The ability to transfer the thermal energy from one mixture component to another is not dependent on the miscibility of the components. Hydrogenation is typically triggered by heat while dehydrogenation is typically triggered by addition of a catalyst (for component #1) or a reactant (for component #2). For example, component 1 can require heat at origination 105 and release heat at the destination 115, while component 2 can release heat at origination 105 and require heat at destination 115. Thus, component 1 would release at least some significant amount heat to component 2 and avoid the need of producing more heat at the destination 115.

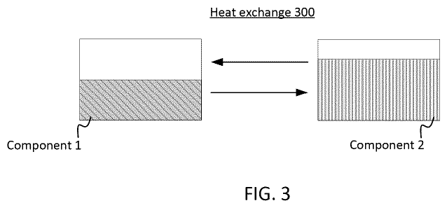

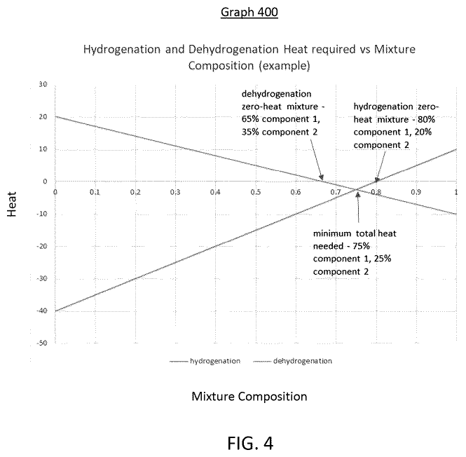

FIG. 3 illustrates a two component heat exchange 300 according to an exemplary embodiment. The two components can exchange heat over the course of transit through multiple means: a conductive wall between the two components or a heat transfer through one or more pipes. Each components can include a specific mixture of elements. Furthermore, each mixture can be of variable volume. Turning to FIG. 4, the graph 400 illustrates how the heat required to perform hydrogenation is related to the mixture composition of components 1 and 2. For a dehydrogenation zero heat mixture, an exemplary system can include 65% of component 1 and 35% of component 2. For a hydrogenation zero heat mixture, an exemplary system can include 80% of component 1 and 20% of component 2. To minimize the heat needed for both hydrogenation and dehydrogenation, an exemplary system can use 75% of component 1 and 25% of component 2. It is understood that the mixtures can vary based on a variety of other factors such as altitude, length of trip, and availability of heat sources at the destination.

t is understood that picking an appropriate mixture of component 1 and component 2 is useful to control the heat required for both hydrogenation and dehydrogenation. For example,

$${c}_{1} {h}_{{1}^{hydrogenate}} + {c}_{2} {h}_{{2}^{hydrogenate}} = heat required / released during hydrogenation$$

$$and$$

$${c}_{1} {h}_{{1}^{dehydrogenate}} + {c}_{2} {h}_{{2}^{dehydrogenate}} = heat required / release during dehydrogenation$$

wherein
c₁=mole fraction of mixture component 1,
c₂=mole fraction of mixture component 2,
h₁^{hydrogenate}=molar heat required/released in hydrogenating component 1,
h₂^{hydrogenate}=molar heat required/released in hydrogenating component 2,
h₁^{dehydrogenate}=molar heat required/released in hydrogenating component 2, and
h₂^{dehydrogenate}=molar heat required/released in hydrogenating component 2.

The concept is not limited to only two components, but could involve multiple components. The limits are only from a practical standpoint. More complex mixtures may require more complex handling (miscibility, viscosity, phase transitions) or multiple catalysts/reactants. The individual mixture components identified above are inert and do not react with other the mixture components. The ability to transfer the thermal energy from one mixture component to another is not dependent on the miscibility of the components. Hydrogenation is typically triggered by heat while dehydrogenation is typically triggered by addition of a catalyst (for mixture component #1) or a reactant (for mixture component #2).

Companies are already working to commercialize each of the components independently (example Hydrogenious for mixture component #1 and HySiLabs for mixture component #2) and have patent portfolios covering the individual mixture components but there are no identified patents that cover mixtures of hydrogen carriers. For example, US20210017021 describes a siloxane based hydrogen carrier. It does mention a “mixture” embodiment, but this is a mixture of linear and cyclic siloxanes all of which require energy to hydrogenate. The mixture is not a mixture of compounds that require energy to hydrogenate with compounds that release energy when hydrogenated. The mixture of the present application is not just a mixture of chemistry but a mixture of energy required/released during hydrogenation. The end goal of this application is not a specific chemistry as describe in US20210017021, but a near-zero net energy required for/released during hydrogenation and/or dehydrogenation.

Component 1 can include without limitation cyclic alkanes, cyclic amines, and combinations thereof. In some embodiments, the cyclic alkane can be methylcyclohexane, decalin, perhydro-dibenzyltoluene, and perhydro-benzyltoluene. In other embodiments, the cyclic amine is dodecahydro-N-ethyl carbazole, 1-methylperhydro indole, 2-methylperhydro indole, 1,2-perhydrodimethyl indole, perhydro-phenazine, or perhydro-2(n-methylbenzyl pyridine). Component 2 or the second component can be one or more of linear siloxanes, cyclic siloxanes, borohydrides, metal hydrides and combinations thereof.

In some embodiments, the linear siloxane is selected from the group consisting of

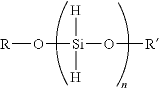

wherein n is an integer (representing the number of repeating units) superior or equal to one and wherein radicals R and R′ don't contain carbon and wherein R and R′ comprises Si and hydrogen and/or oxygen and/or halogen; H3SiOH2nSinOnSiH3, H3SiOH2nSinOnSiH2X, H3SiOH2nSinOnSiHX2, H3SiOH2nSinOnSiX3, H3SiOH2nSinOnSiH2OH, H3SiOH2nSinOnSiH(OH)2, H3SiOH2nSinOnSi(OH)3, XH2SiOH2nSinOnSiH2X, XH2SiOH2nSinOnSiHX2, XH2SiOH2nSinOnSiH2OH, XH2SiOH2nSinOnSiH(OH)2, XH2SiOH2nSinOnSi(OH)3 X2HSiOH2nSinOnSiH2X, X2HSiOH2nSinOnSiHX2, X2HSiOH2nSinOnSiH2OH, X2HSiOH2nSinOnSiH(OH)2, X2HSiOH2nSinOnSi(OH)3 X3SiOH2nSinOnSiH2X, X3SiOH2nSinOnSiHX2, X3SiOH2nSinOnSiX3, X3SiOH2nSinOnSiH2OH, X3SiOH2nSinOnSiH(OH)2, X3SiOH2nSinOnSi(OH)3, (OH)3SiOH2nSinOnSi(OH)3, (OH)3SiOH2nSinOnSiH(OH)2, (OH)3SiOH2nSinOnSiH2OH, or a mixture of one or more of these compounds, with X being a halogen, preferably a halogen selected from F, Cl, Br and I, more preferably Cl, and with n being an integer superior or equal to 1, preferably superior or equal to 2, for example superior or equal to 3, or even superior or equal to four. In an embodiment of the present invention, n is inferior or equal to 500, for example inferior or equal to 50. In other embodiments, the cyclic siloxane is selected from the group consisting of

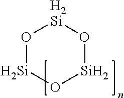

bis(hydro)cyclosiloxanes in which n is preferably between 1 and 2 and a mixture thereof.

In other embodiments, the borohydride is selected from the group consisting of LiBH4, NaBH4, Ba(BH4)2, Mg(BH4)2, Ca(BH4)2, Zn(BH4)2, Al(BH4)2, Sc(BH4)3, Ti(BH4)2, Mn(BH4)2, Zr(BH4)4 and mixtures thereof.

In other embodiments, the metal hydride is selected from the group consisting of LiH, LiAlH4, AlH3, MgH2, Mg2FeH6, BaReH9, LaNi5H6, FeTiH1.7, Mg2Ni5H4, alloys of Ti, Cr, Mn, or V, and mixtures thereof.

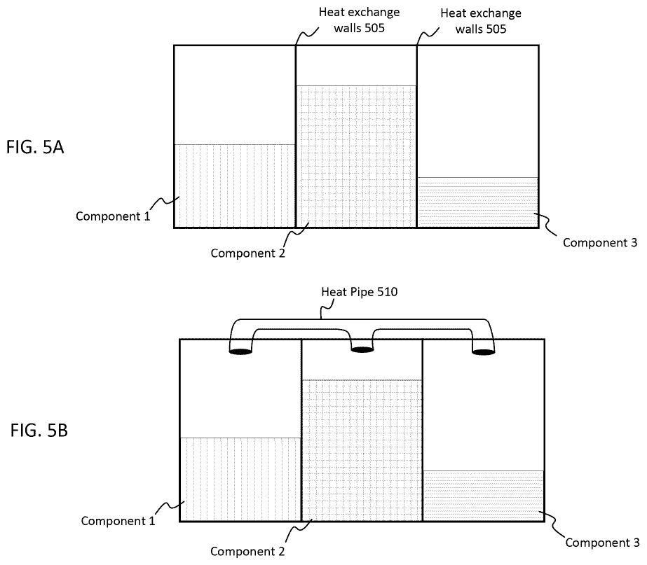

FIGS. 5A and 5B illustrate a multicomponent system with various heat exchange methods. In FIG. 5A, a three component system includes component 1, component 2, and component 3. Each component can be contained in its own enclosed space sharing a conductive wall through heat exchange walls 505. In other embodiments such as FIG. 5B, the heat transfer between components can be performed by a heat pipe 510 connecting each space containing each component. Although FIGS. 5A and 5B disclose three components, it is understood that other embodiments can include more or less components.

In some aspects, the techniques described herein relate to a method for balancing the flow of heat between exothermic dehydrogenation and endothermic dehydrogenation materials to minimize the amount of external heat needed for dehydrogenation including: (a) providing a first component and second component in which the first component absorbs heat during a dehydrogenation process and the second component releases heat during a dehydrogenation process; (b) providing for thermal communication between the first component and the second component; (c) controlling temperature of each of the first and second components so as to control the dehydrogenation rate of reaction; and (d) providing a ratio of first and second components to achieve an objective selected from the group consisting of (i) zero heat added for dehydrogenation, (ii) zero heat added for hydrogenation, (iii) a minimum total heat needed for a full cycle of hydrogenation and dehydrogenation, and (iv) combinations thereof.

In some aspects, the techniques described herein relate to a method wherein the first component is selected from the group consisting of cyclic alkanes; cyclic amines; and combinations thereof.

In some aspects, the techniques described herein relate to a method wherein the cyclic alkane is selected from the group consisting of methylcyclohexane; decalin; perhydro-dibenzyltoluene; perhydro-benzyltoluene.

In some aspects, the techniques described herein relate to a method wherein the cyclic amine is selected from the group consisting of dodecahydro-N-ethyl carbazole; 1-methylperhydro indole; 2-methylperhydro indole; 1,2-perhydrodimethyl indole; perhydro-phenazine; perhydro-2(n-methylbenzyl pyridine).

In some aspects, the techniques described herein relate to a method further including the step of adjusting amounts of the first and second component so as to obtain a result selected from the group consisting of (i) zero heat added for dehydrogenation, (ii) zero heat added for hydrogenation, and (iii) minimum total heat needed for the full cycle of hydrogenation and dehydrogenation.

In some aspects, the techniques described herein relate to a method wherein the second component is selected from the group consisting of (i) linear siloxanes; (ii) cyclic siloxanes; (iii) borohydrides; (iv) metal hydrides and (v) combinations thereof.

In some aspects, the techniques described herein relate to a method wherein the borohydride is selected from the group consisting of LiBH4, NaBH4, Ba(BH4)2, Mg(BH4)2, Ca(BH4)2, Zn(BH4)2, Al(BH4)2, Sc(BH4)3, Ti(BH4)2, Mn(BH4)2, Zr(BH4)4 and mixtures thereof.

In some aspects, the techniques described herein relate to a method wherein the metal hydride is selected from the group consisting of LiH, LiAlH4, AlH3, MgH2, Mg2FeH6, BaReH9, LaNi5H6, FeTiH1.7, Mg2Ni5H4, alloys of Ti, Cr, Mn, or V, and mixtures thereof.

In some aspects, the techniques described herein relate to a system for balancing the flow of heat between exothermic dehydrogenation and endothermic dehydrogenation materials to minimize the amount of external heat needed for dehydrogenation, the system including: a first component configured to absorbs heat during a dehydrogenation process; a second component configured release heat during a dehydrogenation process, wherein a ratio of first and second components to achieve an objective selected from the group consisting of (i) zero heat added for dehydrogenation, (ii) zero heat added for hydrogenation, (iii) a minimum total heat needed for a full cycle of hydrogenation and dehydrogenation, and (iv) combinations thereof; and a thermal communication between the first component and the second component, wherein the temperature of the first and second components can be controlled by the thermal communication to affect a dehydrogenation rate of the dehydrogenation process.

In some aspects, the techniques described herein relate to a system, wherein the system includes a third component in thermal communication with the first and second components.

In some aspects, the techniques described herein relate to a system, wherein the system includes a thermal balancing apparatus configured to measure the heat loss between the first component and the second component.

In some aspects, the techniques described herein relate to a system, wherein the second component is removably attached to the second component.

In some aspects, the techniques described herein relate to a system, wherein the thermal communication includes a heat pipe.

In some aspects, the techniques described herein relate to a system, wherein the thermal communication includes a heat transfer consisting of at least one selected from the group of a change of phase from liquid to gas or a change of phase from gas to liquid.

In some aspects, the techniques described herein relate to a system, wherein the first and second components and the thermal communication are configured to be mobile and stackable for transportation.

In some aspects, the techniques described herein relate to a system for balancing the flow of heat between exothermic dehydrogenation and endothermic dehydrogenation materials to minimize the amount of external heat needed for dehydrogenation, the system including: a first component configured to absorbs heat during a dehydrogenation process; a second component configured release heat during a dehydrogenation process, wherein a ratio of first and second components to achieve an objective selected from the group consisting of (i) zero heat added for dehydrogenation, (ii) zero heat added for hydrogenation, (iii) a minimum total heat needed for a full cycle of hydrogenation and dehydrogenation, and (iv) combinations thereof; wherein the amounts of the first and second components are determined by an equation selected from the group consisting of: (vii) c1h1hydrogenate+c2h2hydrogenate=heat required/released during hydrogenation; (viii) c1h1dehydrogenate+c2h2dehydrogenate=heat required/release during dehydrogenation; (ix) c1+c2=1; c1=mole fraction of mixture component 1, c2=mole fraction of mixture component 2, h1hydrogenate=molar heat required/released in hydrogenating component 1, h2hydrogenate=molar heat required/released in hydrogenating component 2, h1dehydrogenate=molar heat required/released in hydrogenating component 2, h2dehydrogenate=molar heat required/released in hydrogenating component 2, and combinations thereof; and a thermal communication between the first component and the second component, wherein the temperature of the first and second components can be controlled by the thermal communication to affect a dehydrogenation rate of the dehydrogenation process.

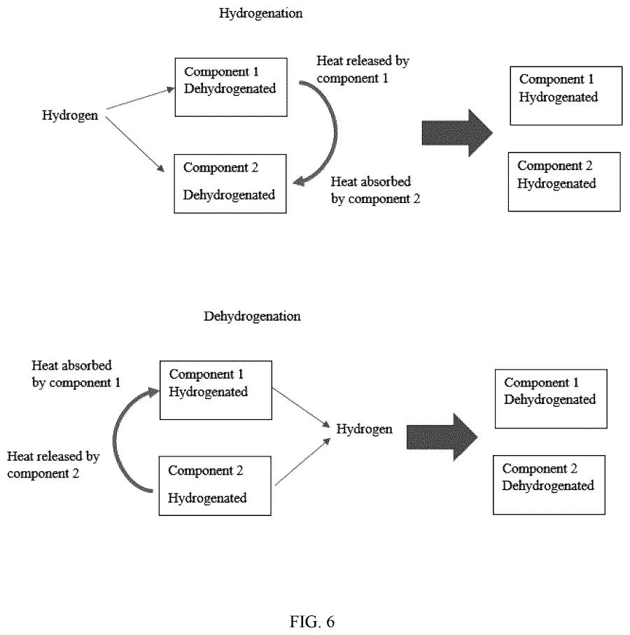

As FIG. 6 demonstrates, the present application pertains in some embodiments to the transfer of heat during hydrogenation and dehydrogenation as opposed to loss of heat during transportation. As shown in FIG. 6 during hydrogenation heat released by component 1 may be absorbed by component 2. During dehydrogenation heat released by component 2 may be absorbed by component 1. Components 1 and 2 are in thermal communication. Such thermal communication may be accomplished in any convenient manner. In some embodiments components 1 and 2 may be at least partially separated by a heat exchanger and/or in thermal communication via a heat pipe. In other embodiments, at least a portion up to all of components 1 and 2 may be physically mixed in a convenient manner.

Although embodiments of the present application have been described herein in the context of a particular implementation in a particular environment for a particular purpose, those skilled in the art will recognize that its usefulness is not limited thereto and that the embodiments of the present application can be beneficially implemented in other related environments for similar purposes. The application should therefore not be limited by the above described embodiments, method, and examples, but by all embodiments within the scope and spirit of the application as claimed.

In the application, various embodiments have been described with references to the accompanying drawings. It may, however, be evident that various modifications and changes may be made thereto, and additional embodiments may be implemented, without departing from the broader scope of the application as set forth in the claims that follow. The application and drawings are accordingly to be regarded in an illustrative rather than restrictive sense.

The application is not to be limited in terms of the particular embodiments described herein, which are intended as illustrations of various aspects. Many modifications and variations can be made without departing from its spirit and scope. Functionally equivalent systems, processes and apparatuses within the scope of the application, in addition to those enumerated herein, may be apparent from the representative descriptions herein. Such modifications and variations are intended to fall within the scope of the appended claims. The application is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the application. The embodiments described should be recognized as capable of implementation separately, or in combination, with other embodiments from the description of the embodiments. A person of ordinary skill in the art reviewing the description of embodiments should be able to learn and understand the different described aspects of the application. The description of embodiments should facilitate understanding of the application to such an extent that other implementations, not specifically covered but within the knowledge of a person of skill in the art having read the description of embodiments, would be understood to be consistent with an application of the presently described invention.

What is claimed is:

1. A method for balancing a flow of heat between exothermic dehydrogenation and endothermic dehydrogenation materials to minimize the amount of external heat needed for dehydrogenation comprising:
a. providing a first component and second component wherein the first component absorbs heat during a dehydrogenation process and wherein the second component releases heat during a dehydrogenation process;
b. providing for thermal communication between the first component and the second component;
c. controlling a temperature of each of the first and second components so as to control a dehydrogenation rate of reaction; and
d. providing a ratio of first and second components to achieve an objective selected from the group consisting of (i) substantially zero heat added for dehydrogenation, (ii) substantially zero heat added for hydrogenation, (iii) a minimal amount of total heat needed for a substantially full cycle of hydrogenation and dehydrogenation, and (iv) any combination thereof.

2. The method of claim 1 wherein the first component is selected from the group consisting of cyclic alkanes; cyclic amines; and any combination thereof.

3. The method of claim 2 wherein the cyclic alkane is selected from the group consisting of methylcyclohexane; decalin; perhydro-dibenzyltoluene; perhydro-benzyltoluene.

4. The method of claim 2 wherein the cyclic amine is selected from the group consisting of dodecahydro-N-ethyl carbazole; 1-methylperhydro indole; 2-methylperhydro indole; 1,2-perhydrodimethyl indole; perhydro-phenazine; perhydro-2(n-methylbenzyl pyridine).

5. The method of claim 1 further comprising adjusting amounts of the first and second component so as to obtain a result selected from the group consisting of (i) substantially zero heat added for dehydrogenation, (ii) substantially zero heat added for hydrogenation, (iii) a minimal amount of total heat needed for the full cycle of hydrogenation and dehydrogenation.

6. The method of claim 5 wherein the amounts of the first and second components are adjusted using an equation selected from the group consisting of:
$${c}_{1} {h}_{{1}^{hydrogenate}} + {c}_{2} {h}_{{2}^{hydrogenate}} = heat required / released during hydrogenation ; \qquad ( i )$$
$${c}_{1} {h}_{{1}^{dehydrogenate}} + {c}_{2} {h}_{{2}^{dehydrogenate}} = heat required / release during dehydrogenation ; \qquad ( ii )$$
$${c}_{1} + {c}_{2} = 1 ; \qquad ( iii )$$
c₁=mole fraction of mixture component 1
c₂=mole fraction of mixture component 2
h₁^{hydrogenate}=molar heat required/released in hydrogenating component 1
h₂^{hydrogenate}=molar heat required/released in hydrogenating component 2
h₁^{dehydrogenate}=molar heat required/released in hydrogenating component 2
h₂^{dehydrogenate}=molar heat required/released in hydrogenating component 2;
and combinations thereof.

7. The method of claim 1 wherein the second component is selected from the group consisting of (i) linear siloxanes; (ii) cyclic siloxanes; (iii) borohydrides; (iv) metal hydrides and (v) any combination thereof.

8. The method of claim 7 wherein the linear siloxane is selected from the group consisting of 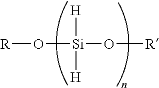
wherein n is an integer (representing the number of repeating units) superior or equal to one and wherein radicals R and R′ do not contain carbon and wherein R and R′ comprises Si and hydrogen and/or oxygen and/or halogen; H3SiOH2nSinOnSiH3, H3SiOH2nSinOnSiH2X, H3SiOH2nSinOnSiHX2, H3SiOH2nSinOnSiX3, H3SiOH2nSinOnSiH2OH, H3SiOH2nSinOnSiH(OH)2, H3SiOH2nSinOnSi(OH)3, XH2SiOH2nSinOnSiH2X, XH2SiOH2nSinOnSiHX2, XH2SiOH2nSinOnSiH2OH, XH2SiOH2nSinOnSiH(OH)2, XH2SiOH2nSinOnSi(OH)3 X2HSiOH2nSinOnSiH2X, X2HSiOH2nSinOnSiHX2, X2HSiOH2nSinOnSiH2OH, X2HSiOH2nSinOnSiH(OH)2, X2HSiOH2nSinOnSi(OH)3 X3SiOH2nSinOnSiH2X, X3SiOH2nSinOnSiHX2, X3SiOH2nSinOnSiX3, X3SiOH2nSinOnSiH2OH, X3SiOH2nSinOnSiH(OH)2, X3SiOH2nSinOnSi(OH)3, (OH)3SiOH2nSinOnSi(OH)3, (OH)3SiOH2nSinOnSiH(OH)2, (OH)3SiOH2nSinOnSiH2OH, or any combination thereof.

9. The method of claim 7 wherein the cyclic siloxane is selected from the group consisting of 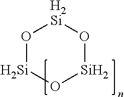
bis(hydro)cyclosiloxanes in which n is between 1 and 20.

10. The method of claim 7 wherein the borohydride is selected from the group consisting of LiBH4, NaBH4, Ba(BH4)2, Mg(BH4)2, Ca(BH4)2, Zn(BH4)2, Al(BH4)2, Sc(BH4)3, Ti(BH4)2, Mn(BH4)2, Zr(BH4)4 and any mixture thereof.

11. The method of claim 7 wherein the metal hydride is selected from the group consisting of LiH, LiAlH4, AlH3, MgH2, Mg2FeH6, BaReH9, LaNi5H6, FeTiH1.7, Mg2Ni5H4, alloys of Ti, Cr, Mn, or V, and any mixture thereof.

12. The method of claim 1 wherein the dehydrogenation rate of reaction is controlled such that the heat absorbed by the first component is substantially the same as the heat released by the second component in amount, temperature, or both.

13. The method of claim 1 wherein the providing for thermal communication between the first component and the second component comprises physically mixing at least a portion of the first component and at least a portion of the second component.

14. A system for balancing a flow of heat between exothermic dehydrogenation and endothermic dehydrogenation materials to minimize amounts of external heat needed for dehydrogenation, the system comprising:
a first component configured to absorb heat during a dehydrogenation process;
a second component configured release heat during a dehydrogenation process, wherein a ratio of the first component and the second component is selected to achieve an objective selected from the group consisting of (i) substantially zero heat added for dehydrogenation, (ii) substantially zero heat added for hydrogenation, (iii) a minimum amount of total heat needed for a full cycle of hydrogenation and dehydrogenation, and (iv) any combination thereof; and
a thermal communication between the first component and the second component, wherein the thermal communication is configured such that a temperature of the first component and the second component can be controlled to affect a dehydrogenation rate of the dehydrogenation process.

15. The system of claim 14, wherein the amount of the first component and the second component is adjusted using an equation selected from the group consisting of:
$${c}_{1} {h}_{{1}^{hydrogenate}} + {c}_{2} {h}_{{2}^{hydrogenate}} = heat required / released during hydrogenation ; \qquad ( i )$$
$${c}_{1} {h}_{{1}^{dehydrogenate}} + {c}_{2} {h}_{{2}^{dehydrogenate}} = heat required / release during dehydrogenation ; \qquad ( ii )$$
$${c}_{1} + {c}_{2} = 1 ; \qquad ( iii )$$
Wherein c₁=mole fraction of mixture component 1
c₂=mole fraction of mixture component 2
h₁^{hydrogenate}=molar heat required/released in hydrogenating component 1
h₂^{hydrogenate}=molar heat required/released in hydrogenating component 2
h₁^{dehydrogenate}=molar heat required/released in hydrogenating component 2
h₂^{dehydrogenate}=molar heat required/released in hydrogenating component 2;
or any combination thereof.

16. The system of claim 14, wherein the system comprises a third component in thermal communication with the first and second components.

17. The system of claim 14, wherein the system comprises a thermal balancing apparatus configured to measure a heat loss between the first component and the second component.

18. The system of claim 14, wherein the second component is removably attached to the second component.

19. The system of claim 14, wherein the thermal communication comprises a heat pipe.

20. The system of claim 14, wherein the thermal communication comprises a heat transfer selected from (i) a change of phase from liquid to gas or (ii) a change of phase from gas to liquid.

21. The system of claim 14, wherein the first and second components and the thermal communication are configured to be mobile, stackable, or both mobile and stackable for transportation.

22. A system for balancing a flow of heat between exothermic dehydrogenation and endothermic dehydrogenation materials to minimize the amount of external heat needed for dehydrogenation, the system comprising:
a first component configured to absorb heat during a dehydrogenation process;
a second component configured to release heat during a dehydrogenation process, wherein a ratio of first and second components are selected to yield (i) substantially zero heat added for dehydrogenation, (ii) substantially zero heat added for hydrogenation, (iii) a minimal amount of total heat needed for a full cycle of hydrogenation and dehydrogenation, or (iv) any combination thereof;
wherein the amounts of the first and second components are selected by using an equation selected from:
$${c}_{1} {h}_{{1}^{hydrogenate}} + {c}_{2} {h}_{{2}^{hydrogenate}} = heat required / released during hydrogenation ;$$
$${c}_{1} {h}_{{1}^{dehydrogenate}} + {c}_{2} {h}_{{2}^{dehydrogenate}} = heat required / release during dehydrogenation ;$$
$${c}_{1} + {c}_{2} = 1 ;$$
c₁=mole fraction of mixture component 1,
c₂=mole fraction of mixture component 2,
h₁^{hydrogenate}=molar heat required/released in hydrogenating component 1,
h₂^{hydrogenate}=molar heat required/released in hydrogenating component 2,
h₁^{dehydrogenate}=molar heat required/released in hydrogenating component 2,
h₂^{dehydrogenate}=molar heat required/released in hydrogenating component 2,
or any combination thereof; and
a thermal communication between the first component and the second component, wherein the system is configured such that a temperature of the first component and the second component is controlled by the thermal communication to affect a dehydrogenation rate of the dehydrogenation process.
